(19) United States
(12) Patent Application Publication
(10) Pub. No.: US 2013/0276391 A1
(43) Pub. Date: Oct. 24, 2013

(54) Buck System

(71) Applicant: Knut Horneland, Tampa, FL (US)

(72) Inventor: Knut Horneland, Tampa, FL (US)

(21) Appl. No.: 13/484,891

(22) Filed: May 31, 2012

Related U.S. Application Data
(63) Continuation-in-part of application No. 13/451,614, filed on Apr. 20, 2012, now Pat. No. 8,495,843.

(51) Int. Cl. E06B 1/24; E04G 21/02

(52) U.S. Cl. CPC E06B 1/24; E04G 21/02
USPC 52/215; 52/742.14

(57) ABSTRACT

A buck system for forming and framing an opening in a poured concrete foundation includes a plurality of buck sections sized to match the desired dimension of an opening. Each of the buck sections is affixed to an adjacent buck section by brackets forming a closed geometric shape. Each buck section has an inner surface defining an inside dimension of the opening and each of the buck sections has a first channel and a second channel. The first channel snuggly accepts an edge of a first insulated concrete foundation wall of the insulated concrete foundation walls and the second channel snuggly accepts an edge of a second insulated concrete foundation wall of the insulated concrete foundation walls.

### CROSS-REFERENCE TO RELATED PATENTS

This application is a continuation-in-part of co-pending application Ser. No. 13/451,614, titled “Buck System,” attorney docket number 3247.0, filed Apr. 20, 2012, the disclosure of which is hereby included by reference.

This application is related to U.S. application titled, “Buck Bracket,” which was filed on even date herewith; attorney docket number 3247.3 and inventor Knut Horneland.

For reference and understanding of Insulated Concrete Forms (ICF), U.S. Pat. No. 5,896,714 to Cymbala, et al, issued Apr. 27, 1999, describes an exemplary insulated concrete forming system and is hereby incorporated by reference.

### FIELD

This invention relates to bucks used for forming an opening in a wall and more particularly to a buck system for forming an opening in a poured concrete wall in which the concrete is poured between Insulated Concrete Forms.

### BACKGROUND

Most windows and other openings in buildings include frames (e.g. window frames) and inserts (e.g. window glass panels, doors, etc.). For framed construction, rough framing is constructed before the frames (window frame, door frame) are installed and the rough framing is constructed sufficiently to support structures above the opening by extra studs and headers, etc.

For poured concrete installations, generally the frame is not strong enough to withstand the weight of the poured concrete. Furthermore, the typical frame does not provide sufficient rigidity for the openings after the building is completed, the walls are formed around the window opening, and the concrete dries.

To solve this problem, a rigidifying box or outer-frame called a “buck” is typically formed or built to provide a receptacle or opening into which the frames can be mounted after the concrete is poured.

In Modern construction techniques, the walls of portions or of the entire building are formed by pouring concrete into forms or molds. This method has long been done in the fabrication of basement walls, either created on-site or off-site in which an entire wall is pre-fabricated then positioned into a vertical position and installed on-site.

Bucks for use with poured concrete walls have been disclosed in the prior art. For example, U.S. Pat. No. 5,996,293 to Anderson, et al, describes a buck system made by extruding vinyl. Bucks of any useful dimension that are made according to this disclosure are not sturdy enough to withstand the force of wet, poured concrete and, therefore, require many braces to prevent sagging and/or collapse after the concrete is poured. Furthermore, the described buck system does not adequately accommodate Insulated Concrete Forms (ICFs), which have become very popular in the construction industry.

In another example, U.S. Pat. No. 6,070,375 to Anderson, et al, describes a buck system made by extruding vinyl. Again, Bucks of many useful dimension that are made according to disclosure are not sturdy enough to withstand the force of wet, poured concrete and, therefore, require many braces to prevent sagging and/or collapse after the concrete is poured.

In another example, U.S. Pat. No. 6,530,185 to Scott, et al, describes a buck system for Insulated Concrete Forms that is made of plastic. Again, Bucks of many useful dimensions that are made according to the disclosed system are not sturdy enough to withstand the force of wet, poured concrete and, therefore, require many braces to prevent sagging and/or collapse after the concrete is poured.

In all of the above examples, the overall construction, materials and design does not provide added structure to the ICF and, for all useful sizes of frames, requires substantial bracing and squaring (corner angles).

What is needed is a buck system that will support the force and weight of concrete with no or minimal bracing and will provide a sturdy base for frames.

### SUMMARY

In one embodiment, a buck system for forming and framing an opening in a poured concrete foundation is disclosed. The foundation being poured between two insulated concrete foundation walls. The buck system includes a plurality of buck sections of lengths that match the desired dimension of the opening. Each of the plurality of buck sections is affixed to an adjacent buck section of the plurality of buck sections by brackets, thereby forming a closed geometric shape. Each of the buck sections has a first side section, a second side section and a center section. The first side section is affixed to a first top surface of the center section and the second side section is affixed to a second, distal top surface of the center section. The first side section has an first side section outer wall which forms a first channel between the inner surface of the first side section outer wall and a first side of the center section. The second side section has a second side section outer wall which forms a second channel between the inner surface of the second side section outer wall and a second side of the center section. The first channel snuggly accepts an edge of a first insulated concrete foundation wall of the two insulated concrete foundation walls and the second channel snuggly accepts an edge of a second insulated concrete foundation wall of the two insulated concrete foundation walls.

In another embodiment, a method of making a framed opening in a poured concrete foundation is disclosed. The foundation being poured between two insulated concrete foundation walls. The method including providing a plurality of the buck sections of the above embodiment in lengths that match the desired dimension of the opening and in which the width of the center sections being approximately the distance between inside surfaces of the two insulated concrete foundation walls. Next, each of the plurality of buck sections are affixed to an adjacent buck section of the plurality of buck sections forming a closed geometric shape then, the edges of a first insulated concrete foundation wall of the insulated concrete foundation walls are positioned into the first channel and the edges of a second insulated concrete foundation wall of the insulated concrete foundation walls are positioned into the second channel. Next, concrete is poured between the first insulated concrete wall and the second insulated concrete wall.

In another embodiment, a buck system for forming and framing an opening in a poured concrete foundation is disclosed. The foundation is poured between two insulated concrete foundation walls. The buck system includes a plurality of buck sections of lengths that match the desired dimension of the opening. Each of the plurality of buck sections is affixed to an adjacent buck section forming a closed geometric shape. Each of the buck sections includes a center section made from a C-stud. Each buck section also includes a first side section affixed to a first side of the center section and a second side section affixed to an opposing side of the center section. The first side section has a first side section outer wall, forming a first channel between the inner surface of the first side section outer wall and a first side of the center section. The second side section has a second side section outer wall, forming a second channel between the inner surface of the second side section outer wall and a second side of the center section, The first channel snuggly accepts an edge of a first insulated concrete foundation wall of the two insulated concrete foundation walls and the second channel snuggly accepts an edge of a second insulated concrete foundation wall of the two insulated concrete foundation walls.

### BRIEF DESCRIPTION OF THE DRAWINGS

The invention can be best understood by those having ordinary skill in the art by reference to the following detailed description when considered in conjunction with the accompanying drawings in which:

FIG. 1A illustrates a cross-sectional view of a first example of a section of the buck system.

FIG. 1B illustrates a perspective view of the first example of the buck system installed as a window rough frame in an insulated concrete foundation.

FIG. 2A illustrates a cross-sectional view of a second example of a section of the buck system.

FIG. 2B illustrates a perspective view of the second example of the buck system installed as a window rough frame in an insulated concrete foundation.

FIG. 3A illustrates a cross-sectional view of a third example of a section of the buck system.

FIG. 3B illustrates a perspective view of the third example of the buck system installed as a window rough frame in an insulated concrete foundation.

FIG. 4A illustrates a cross-sectional view of a fourth example of a section of the buck system.

FIG. 4B illustrates a cross-sectional view of a modified fourth example of a section of the buck system.

FIG. 5A illustrates a cross-sectional view of the modified fourth example of a section of the buck system of one particular width.

FIG. 5B illustrates a cross-sectional view of the modified fourth example of a section of the buck system of one particular width.

FIG. 6 illustrates a cross-sectional view of the modified fourth example of a section of the buck system including an angle bracket.

FIG. 7 illustrates a perspective view of the fourth example of the buck system installed as a window rough frame in an insulated concrete foundation.

FIG. 8 illustrates a perspective view of a buck bracket.

FIG. 9 illustrates a cross-sectional view of the modified fifth example of a section of the buck system.

FIG. 10 illustrates a perspective view of two sections of the modified fifth example of buck system connected using the buck bracket.

FIG. 11 illustrates a perspective view of the fifth example of the buck system connected using the buck bracket and installed as a window rough frame in an insulated concrete foundation.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout the description, the terms “insulated concrete foundation” and “insulated concrete foundation wall” refer the well-known system of fabrication of concrete walls, not necessarily limited to foundation walls, but to any concrete wall of a structure, including interior walls and higher story walls, etc.

The disclosed buck system provides an anchoring base for windows and doors that will provide extreme resistance to fenestration failures with wind damage situations such as hurricanes. The disclosed buck system provides the proper pull out strength required in the various wind/hurricane zone areas often required by building and life safety codes.

Throughout this description, reference is made to various components of the buck system by their cross-sectional appearance (e.g., U-shaped and C-shaped). Note that U-shaped and C-shaped are interchangeable, in that, rotating of a U-shape by 90 degrees results in a C-shape, and orientation is not of concern. That being said, U-shape and C-shape refer to the general cross-sectional shape of, for example, typical steel C-studs or any equivalent shape with flat or curved walls, pointed or rounded corners, and with or without closing angled edges.

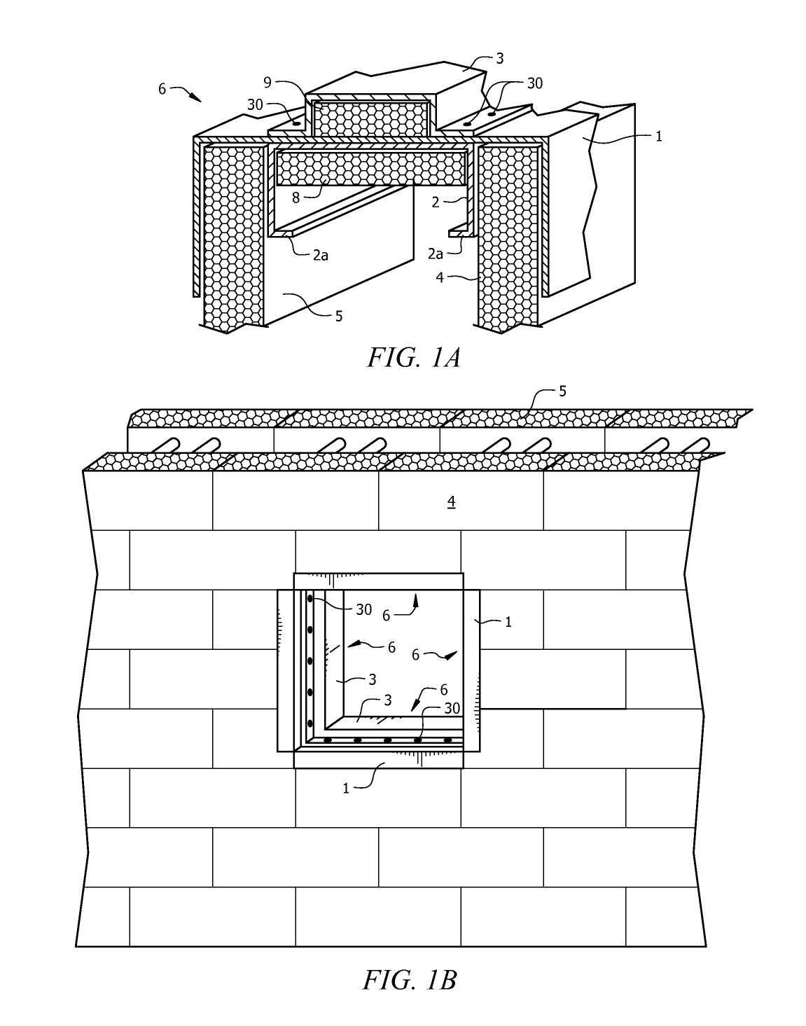

Referring to FIGS. 1A and 1B, a cross-sectional view of a first example of the buck section 6 is shown. The buck section 6 is shown installed in an insulated concrete foundation 4/5 in FIG. 1B. The buck section 6 in this example includes three components: an outer U-shaped member 1, an inner U-shaped member 2 with bent edges 2a and a hat member 3.

The space between the inside of the side edges of the outer U-shaped member 1 and the outside of the side edges of the inner U-shaped member 2 form channels for receiving the edges of the insulated concrete foundation walls. The insulated concrete foundation walls 4/5 fit between snuggly in these channels between the inside of the side edges of the outer U-shaped member 1 and the outside of the side edges of the inner U-shaped member 2.

The hat is part of and/or affixed to the outside of the base of the outer u-shaped member 1. The components 1/2/3 of the buck section 6 are made of a sturdy material including, but not limited to, steel, iron, polyvinylchloride (PVC), etc., although steel is preferred. It is preferred to use a structurally strong material such as steel to eliminate and/or greatly reduce the need for bracing while concrete is poured into the gap between the insulated concrete foundation walls 4/5. In this, the buck sections 6 receive fluid pressure from the concrete (until the concrete sets) as well as pressure from the weight of the concrete. The buck section 6 is self-supporting for openings of up to approximately 3.5 feet when the components 1/2/3 are made of, for example, 20 gauge steel. For wider spans, it is anticipated that the components 1/2/3 are made from a heavier gauge steel such as 16 gauge steel and/or minimal bracing is provided during pouring of the concrete and until the concrete sets.

The components 1/2/3 are formed as one piece or held together such as with fasteners 30 (screws are shown). When screws are used as fasteners 30, it is anticipated that the screws are spaced at 8″ distances, though any spacing is anticipated.

To create the desired rough frame, a number of sections of the buck section 6 are provided/cut to the desired dimensions and the sections are then fastened to each other by, for example, clips. The example shown in FIG. 1B has four sections of the buck system 6 and four clips (not shown) holding the corners of the sections of the buck system 6 together. Note that, although a rectangular rough frame is shown in FIG. 1B, any shape rough frame is anticipated (e.g., hexagonal, octagonal, etc).

The hat member 3 typically interfaces with the window frame, door frame, etc. When the frame is installed into the rough frame constructed from multiple sections of the buck section 6, fasteners are typically set through the frame and into the buck section 6, in particular, the hat 3 of the buck section 6.

In some embodiments, some or the entire gap between the inner sides of the hat 3 and the outer side surface of the outer u-shaped member 1 is filled with a soft material 9 such as Styrofoam. This serves at least two purposes. The soft material 9 reduces flow of concrete into this gap and provides some amount of insulation. It is desired to prevent/reduce flow of concrete into this gap so that, after the concrete is poured and sets, fasteners (e.g. nails, screws, etc. not shown) are not blocked by hardened concrete (e.g. when the frame is installed into the rough frame).

In some embodiments, the base of the inner u-shaped member 2 is lined with a section of a soft material 8 such as Styrofoam, again providing some amount of insulation between the concrete and the buck section 6, but also preventing/reducing flow of concrete into this gap so that, after the concrete is poured and sets, fasteners (e.g. nails, screws, etc.) are not blocked by hardened concrete.

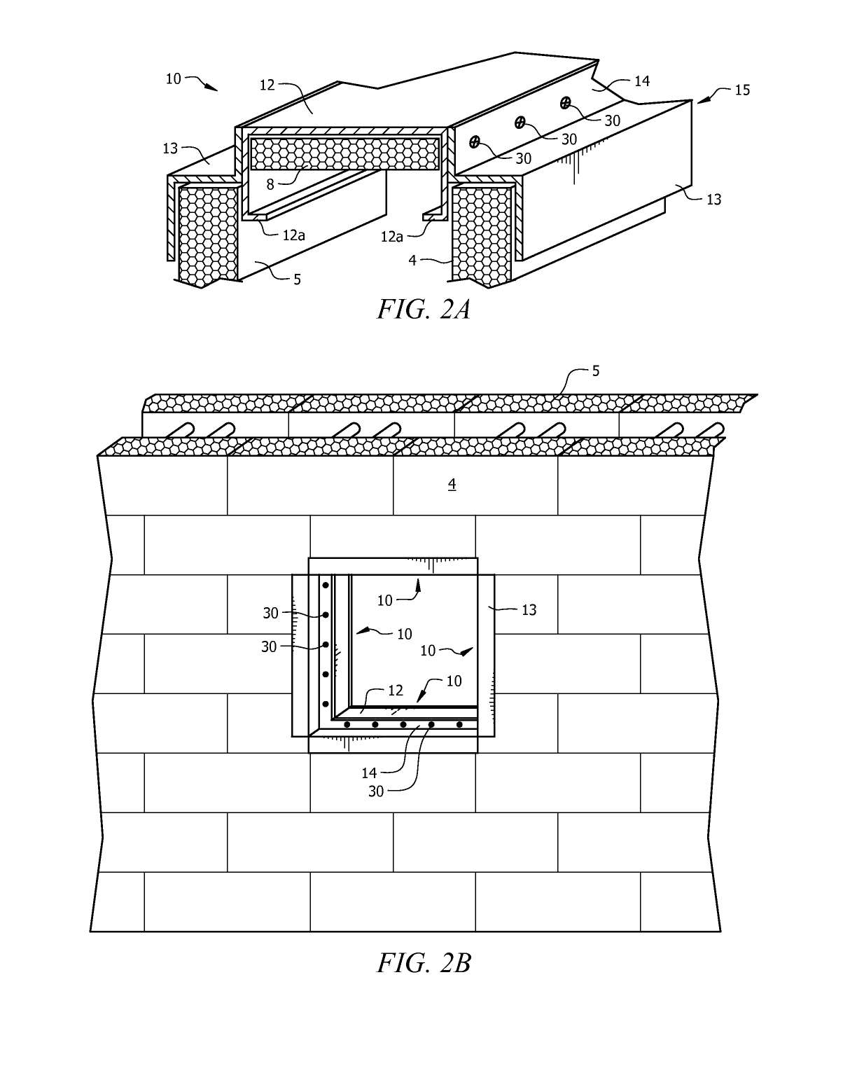

Referring to FIGS. 2A and 2B, a cross-sectional view of a second example of the buck section 10 is shown. The buck section 10 is shown installed in an insulated concrete foundation 4/5 in FIG. 2B. The buck section 10 in this example includes three components: two outer Z-shaped members 15 and an inner U-shaped member 12 with bent edges 12a.

The space between the inside of the side edges 13 of the Z-shaped member 15 and the outside of the side edges of the inner U-shaped member 12 form channels for receiving the edges of the insulated concrete foundation walls. The insulated concrete foundation wall edges 4/5 fit between snuggly within these channels between the inside of the side edges 13 of the Z-shaped member 15 and the outside of the side edges of the inner U-shaped member 12.

Each of the Z-shaped members are part of and/or affixed to outer surfaces of the side edges of the inner U-shaped member, for example using screws. The components 12/15 of the buck section 10 are made of a sturdy material including, but not limited to, steel, iron, polyvinylchloride (PVC), etc., although steel is preferred. It is preferred to use a structurally strong material such as steel to eliminate and/or greatly reduce the need for bracing while concrete is poured into the gap between the insulated concrete foundation walls 4/5. In this, the buck sections 10 receive fluid pressure from the concrete (until the concrete sets) as well as pressure from the weight of the concrete. The buck section 10 is self-supporting for openings of up to approximately 3.5 feet when the components 12/15 are made of, for example, 20 gauge steel. For wider spans, it is anticipated that the components 12/15 are made from a heavier gauge steel such as 16 gauge steel and/or minimal bracing is provided during pouring of the concrete and until the concrete sets.

The components 12/15 are formed as one piece or held together such as with fasteners 30 (screws are shown). When screws are used as fasteners 30, it is anticipated that the screws are spaced at 8″ distances, though any spacing is anticipated.

To create the desired rough frame, a number of the buck section 10 are provided/cut to the desired dimensions and the sections are then fastened to each other by, for example, clips. The example shown in FIG. 2B has four buck sections 10 and four clips (not shown) holding the corners of the sections of the buck section 10 together. Note that, although a rectangular rough frame is shown in FIG. 2B, any shape rough frame is anticipated (e.g., hexagonal, octagonal, etc.).

The inner U-shaped member 12 typically interfaces with the window frame, door frame, etc. When the frame is installed into the rough frame constructed from multiple buck sections 10, fasteners are typically set through the frame and into the buck section 10, in particular, the fasteners are set into the outer surface of the base of the U-shaped member 12 of the buck section 10.

In some embodiments, the base of the inner u-shaped member 12 is lined with a section of a soft material 8 such as Styrofoam, providing some amount of insulation between the concrete and the buck section 10, but also preventing/reducing flow of concrete into this area against the inner surface of the base of the U-shaped member 12 so that, after the concrete is poured and sets, fasteners (e.g. nails, screws, etc.) are not blocked by hardened concrete.

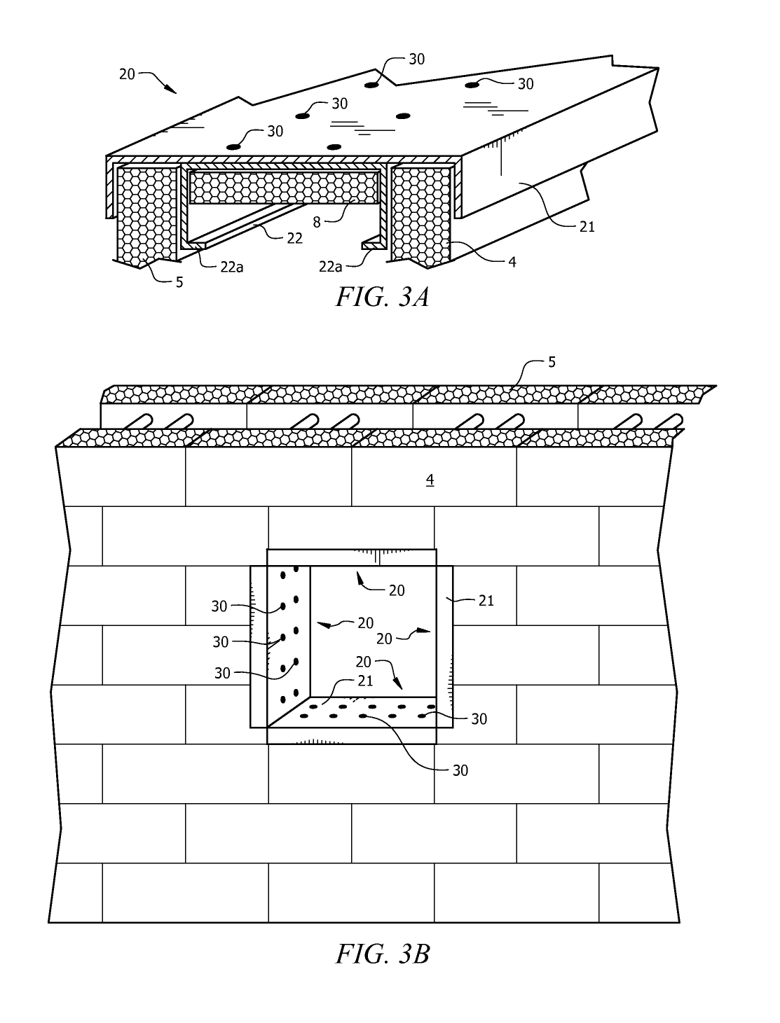

Referring to FIGS. 3A and 3B, a cross-sectional view of a first example of the buck section 20 is shown. The buck section 20 is shown installed in an insulated concrete foundation 4/5 in FIG. 3B. The buck section 20 in this example includes two components: an outer U-shaped member 21 and an inner U-shaped member 22 with bent edges 22a.

The space between the inside of the side edges of the outer U-shaped member 21 and the outside of the side edges of the inner U-shaped member 22 form channels for receiving the edges of the insulated concrete foundation walls. The edges of the insulated concrete foundation walls 4/5 fit snuggly in these channels between the inside of the side edges of the outer U-shaped member 21 and the outside of the side edges of the inner U-shaped member 22.

The outer U-shaped member is part of and/or affixed to outer top surfaces of the inner U-shaped member 22, for example using screws. The components 21/22 of the buck section 20 are made of a sturdy material including, but not limited to, steel, iron, polyvinylchloride (PVC), etc., although steel is preferred. It is preferred to use a structurally strong material such as steel to eliminate and/or greatly reduce the need for bracing while concrete is poured into the gap between the insulated concrete foundation walls 4/5. In this, the buck sections 20 receive fluid pressure from the concrete (until the concrete sets) as well as pressure from the weight of the concrete above. The buck sections 20 are self-supporting for openings of up to approximately 3.5 feet when the components 21/22 are made of, for example, 20 gauge steel. For wider spans, it is anticipated that the components 21/22 are made from a heavier gauge steel such as 16 gauge steel and/or minimal bracing is provided during pouring of the concrete and until the concrete sets.

The components 21/22 are formed as one piece or held together such as with fasteners 30 (screws are shown). When screws are used as fasteners 30, it is anticipated that the screws are spaced at 8″ distances, though any spacing is anticipated.

To create the desired rough frame, a number of buck sections 20 are provided/cut to the desired dimensions and the sections are then fastened to each other by, for example, clips. The example shown in FIG. 3B has four buck sections 20 and four clips (not shown) holding the corners of the buck sections 20 together. Note that, although a rectangular rough frame is shown in FIG. 3B, any shape rough frame is anticipated (e.g., hexagonal, octagonal, etc.).

The inner U-shaped member 22 typically interfaces with the window frame, door frame, etc. When the frame is installed into the rough frame constructed from multiple sections of the buck section 20, fasteners are typically set through the frame in into the buck section 20, in particular, the fasteners are set into the outer surface of the base of the U-shaped member 22 of the buck 20.

In some embodiments, the base of the inner u-shaped member 22 is lined with a section of a soft material 8 such as Styrofoam, providing some amount of insulation between the concrete and the buck section 20, but also preventing/reducing flow of concrete into this area against the inner surface of the base of the U-shaped member 22 so that, after the concrete is poured and sets, fasteners (e.g. nails, screws, etc.) are not blocked by hardened concrete.

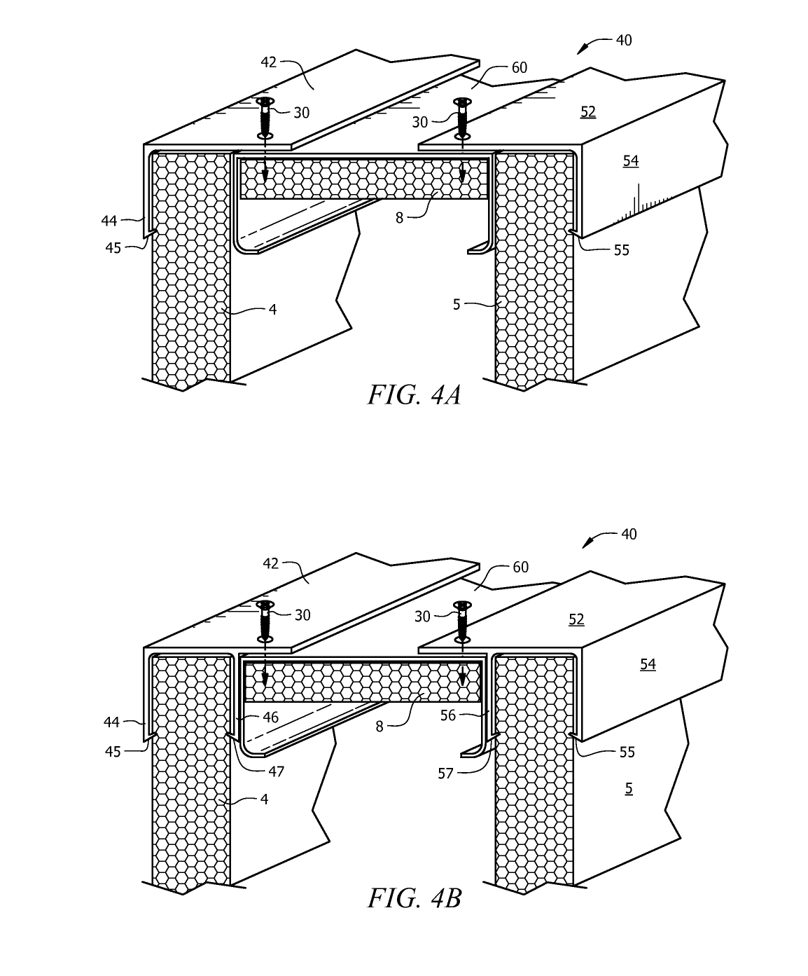

Referring to FIGS. 4A and 4B, cross-sectional views of a fourth example of a section of the buck system 40 are shown. This buck system comprises three main sections. There are two side section 42/52 and a center section 60. The side sections 42/52 have outer walls 44/54 and, optionally, inner walls 46/56 (as shown in FIG. 4B). Channels are formed between the outer walls 44/54 and either the inner walls 46/56 or the sides of the center section 60. The channels snuggly contain the end edge of the insulated concrete foundation sections 4/5. In some embodiments, barbs 45/55 are included on inside surfaces of the outer walls 44/54 (inside surface is that which interfaces with the insulated concrete foundation panels). Additionally, in embodiments having inner walls 46/56 (as in FIG. 4B), inside barbs 47/49 are optionally formed on the inside surfaces of the inside walls 46/56. These barbs 45/47/55/57 improve positionability and stability of the buck systems 40 during installation.

It is anticipated that the two side sections 42/52 be fabricated by any means known out of any suitable structural material such as extruded rigid plastic, molded plastic, extruded steel, PVC, etc.

It is anticipated that the center section 60 is also fabricated by any means known out of any suitable structural material such as extruded rigid plastic, molded plastic, extruded steel, PVC, etc., though it is preferred that the center section 60 be standard metal studs (e.g. steel) of a width selected to approximate the gap between the insulated concrete foundation walls 4/5. One such standard metal stud is known in the industry as C-joists that are typically available in a range of widths (e.g. 3⅝″ or 5½″, etc.) and lengths. In such, the metal studs are cut to the appropriate length for the dimensions of the opening.

The side sections 42/52 are fastened to the center section 60 by fasteners 30, for example screws 30. In such, it is preferred, though not required, that the screws be self-tapping and tap into the center section 60. Any size and number of screws 30 are anticipated at any desired centers, for example, at 8″ centers.

As in the previous examples, the inner surface of the center section 60 is lined with a section of a soft material 8 before pouring of the concrete (e.g., Styrofoam), again providing some amount of insulation between the concrete and the buck section 66, but also preventing/reducing flow of concrete into this gap so that, after the concrete is poured and sets, fasteners (e.g. nails, screws, etc.) are not blocked by hardened concrete.

The center section 60 is preferably made of a standard C-shape metal stud, but any similar member is anticipated, such as an extruded or molded plastic section of similar structure.

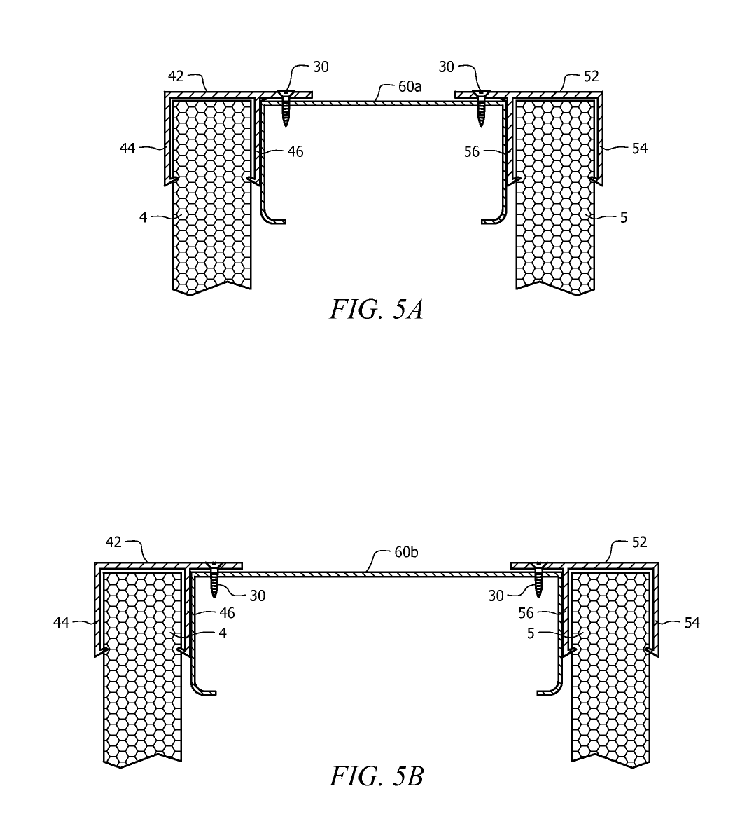

Referring to FIGS. 5A and 5B, cross-sectional views of the modified fourth example of a section of the buck system 40 of varying width are shown. The views of FIGS. 5A and 5B demonstrate the flexibility of the buck system 40 in accommodating various foundation wall thicknesses (distance from the inner surface of one wall 4 of the insulated concrete foundation and the inner side of the opposite wall 5 of the insulated concrete foundation 5).

In FIG. 5A, a narrower center section 60 (e.g., 3½″ C-Stud) is used for a narrower foundation such as for a 3½″ concrete foundation (3½″ concrete thickness). Similarly, in FIG. 5B, a wider center section 60 (e.g. 6″ C-Stud) is used for a wider foundation such as for a 6″ concrete foundation. The fourth example buck system 40 is flexible and, for some applications, the side sections 42/52 are fastened to the center section 60 when needed so that it is possible to decide on the width of the center section 60, for example, at the job site. It is known in the industry to refer to a 3½ inch wide stud as an ×4 stud (e.g. a 2×4 stud), though some studs do not follow this standard used typically for pine studs that are cut to, for example, 4″ widths and shrink down to 3½″ width during drying. The goal is to match the actual width (as measured) as closely as possible to the resulting width of the concrete after it is poured into the ICF.

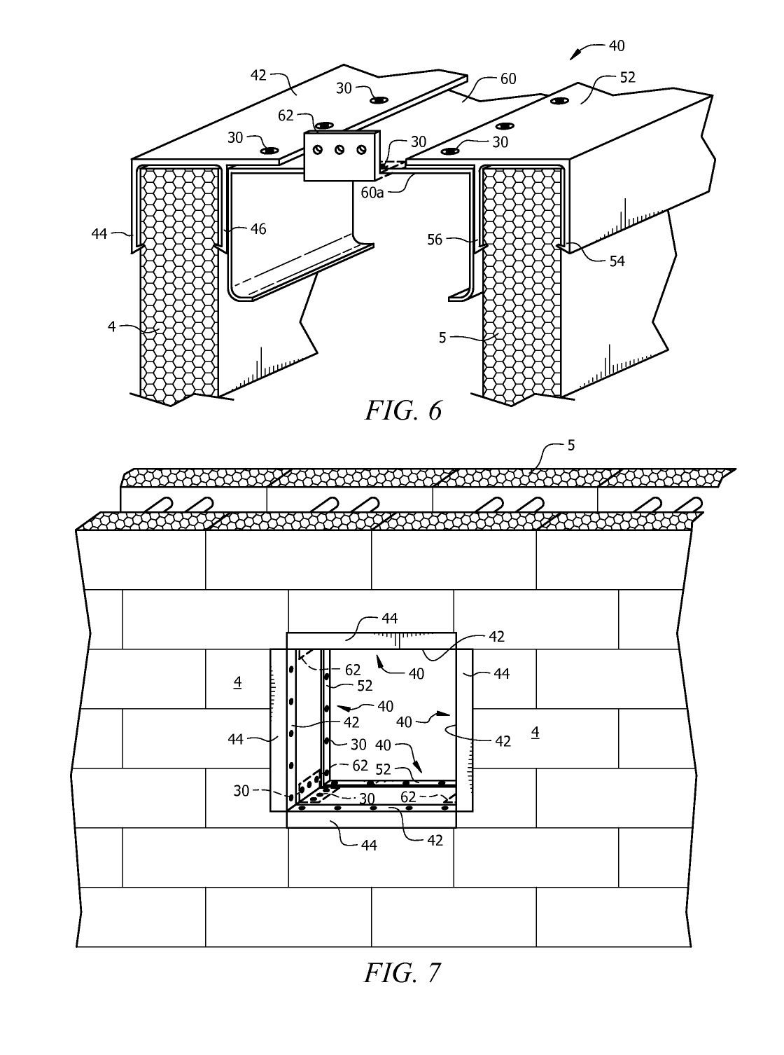

Referring to FIG. 6, a cross-sectional view of the modified fourth example of a section of the buck system 40 is shown including an angle bracket 62. The angle bracket 62 connects two adjacent sections of buck system 40, therefore, for rectangular openings, angle brackets 62 are installed at each corner. Although not required, it is anticipated that narrower angle brackets are also placed connecting the side sections 42/52 to provide added strength. As shown, fasteners 30 affix the angle brackets 62 to the center sections 60, and/or the side sections 42/52 when present. In such, it is preferred, though not required, that the fasteners 30 pass through the center sections 60, then into the angle bracket 62. One example is a self-taping screw 30 that passes through a hole in the center section 60, and then taps into the bracket 62. Although 90 degree angle brackets 62 are shown, any angle is anticipated to match the geometry of the opening (e.g. hexagon, octagon, etc.).

Referring to FIG. 7, a perspective view of the fourth example of the buck system 40 is shown installed as a window rough frame in an insulated concrete foundation 4/5. Four sections of the buck system 40 are shown forming a rectangular opening that will later hold, for example, a window frame (not shown). Two of the four angle brackets 62 are shown hidden beneath adjacent center sections 60 of the buck system 40, holding the sections of the buck system 40 at substantially right angles. Although it is preferred to install the angle brackets 62 behind/outside of the center sections 62, there is no limitation as to the location and/or number of angle brackets 62 so long as the angle brackets 62 maintain a connection between adjacent sections of the buck system 40.

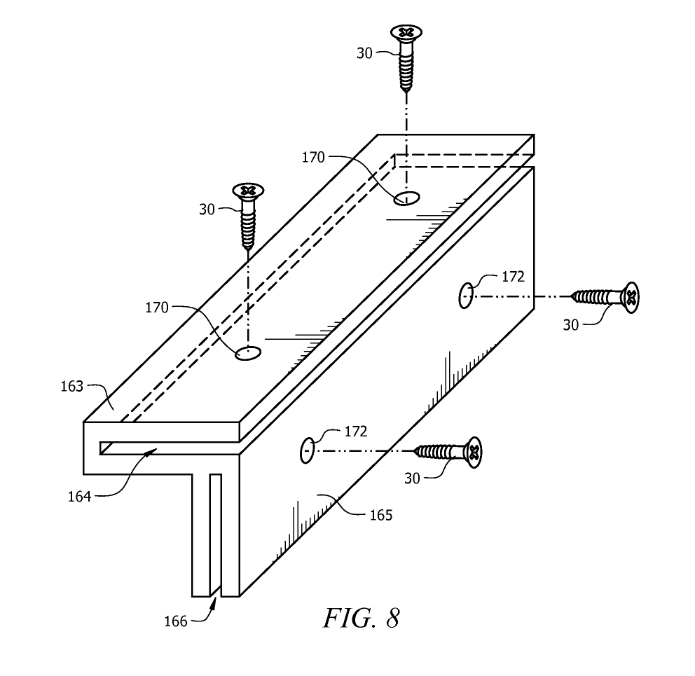

Referring to FIG. 8, a perspective view of a buck bracket 162 is shown. The prior examples of angle brackets 62 provided for very little overlap between adjacent buck sections. For example, as shown in FIG. 7, the angle bracket 62 holds edges of two sections 60 of the buck system 40 in an abutting position. In this, the angle bracket 62 supplies much of the strength between the adjacent sections 60. Furthermore, it is possible for a slight gap between adjacent sections 60 through which it is possible for concrete to ooze during pouring. Although such a system works perfectly well, the buck bracket 162 provides advantages over L-brackets 62.

The buck bracket 162 has a body, in this example including two sides 163/165. The sides 163/165 are formed at an angle to each other in (a 90 degree angle in the example shown) though any angle other than zero and 180 degrees is anticipated to match the geometry of the opening being formed in a foundation (e.g. 60 degrees for a hexagonal opening). In each side 163/165 is a slotted aperture 164/166. Each slotted aperture 164/166 is open at one side for accepting an edge of a buck section 60 and closed at a distal side thereby capturing the edge of the buck section 60 within the slotted aperture 164/166. The first slotted aperture 164 is substantially lengthwise parallel to the second slotted aperture 166 and the first slotted aperture 164 is depth-wise at an angle to the second slotted aperture 166, typically any angle other than zero degrees and 180 degrees.

The slotted aperture 164 of a first side 163 overlaps the slotted aperture 165 of the second side 166. In this way one buck section 60 overlaps the adjacent buck section 60 forming a ‘T’. This overlap provides enhanced structural strength. For example, as viewed in FIG. 8, as force is exerted downwardly on a horizontal buck section 60 in the first slotted aperture 164, the force is supported by the upper edge of the adjacent vertical buck section 60 that is positioned in the second slotted aperture 166. This provides improved strength, for example, when the concrete is initially poured. Although not required, it is preferred that the overlap be approximately the width of, for example, the outer walls 44/54.

Although optional, the buck brackets 162 are shown with pre-drilled holes or pilot holes 170/172 for accepting fasteners 30 to hold the buck sections 60 within the buck brackets 162. Note, the buck brackets 162 are anticipated for use with any buck system, including, but not limited, to buck systems disclosed here within.

It is anticipated that the buck bracket 162 be made of any suitable material, including, but not limited to, sturdy plastic, metal, and polyvinyl chloride (PVC).

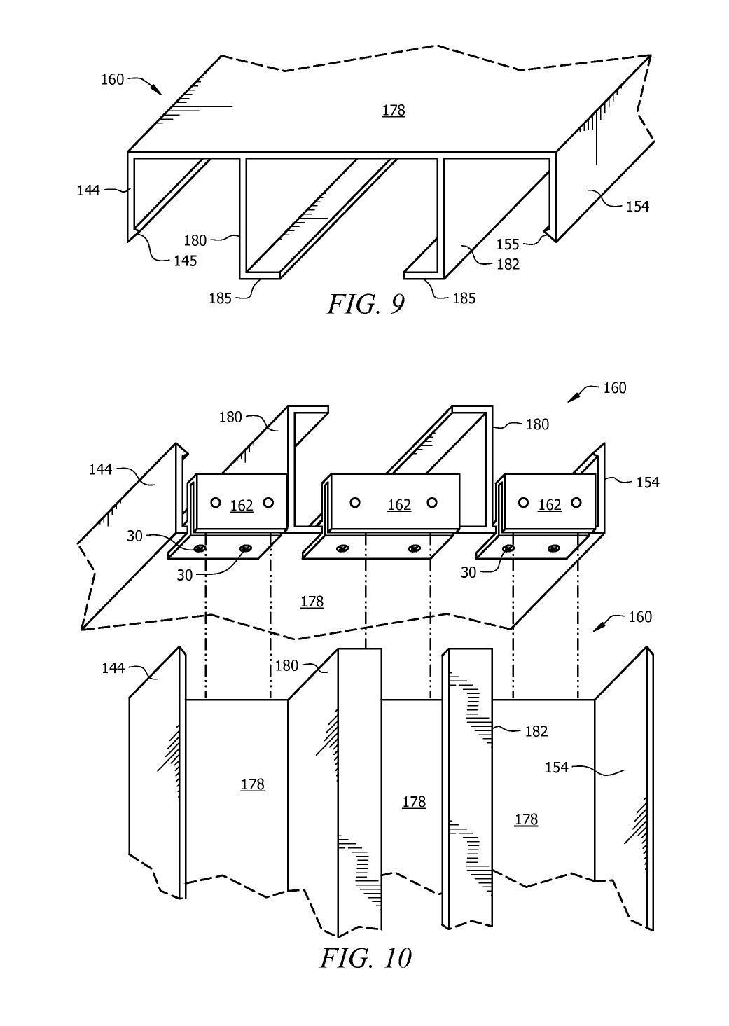

Referring to FIGS. 9 through 11, a modified fifth example of buck system 160 is shown. This buck system 160 is made from a single section, molded or extruded, including four walls 144/180/182/154 and a base 178. The substantially planar side of the base 178 forms the walls of the opening in the foundation into which the window, door, etc., will be installed. The four walls 144/180/182/154 depend, approximately perpendicular from an opposite side of the base 178. Again, the base 178 and four walls 144/180/182/154 are formed as one piece, for example, extruded from steel or plastic, or molded in the shape shown. Any length is anticipated.

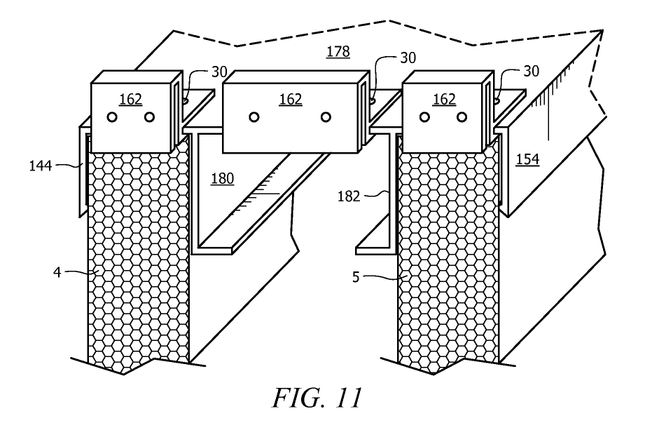

The area between the inner surfaces of the first outer wall 144 and a first inner wall 180 fits snuggly around a first ICF wall 4 as shown in FIG. 11. The area between the inner surfaces of the second outer wall 154 and the second inner wall 182 fits snuggly around a second ICF wall 5 as shown in FIG. 11. The distance between the inner walls 180/182 is preferably similar to the width of the concrete (after it is poured between the walls 4/5 of the ICF.

After connecting the sections of this buck system 160 and connecting them with the ICF, concrete poured between the walls 4/5 of the ICF flows into the channel between the inner walls 180/182. Although shown with a C-shaped cross section having edge flanges 185, any shape edge is anticipated. Note, the example shown has optional barbs 145/155, though the barbs 145/155 are not present in all embodiments. When present, the barbs 145/155 help position and hold the buck system 160 to the walls 4/5 of the ICF until the concrete is poured and sets.

In FIG. 10, two sections 160 of the fifth buck system are shown being joined by the buck brackets 162. Note that although three buck brackets 162 are shown joining two adjacent buck sections 160, any number of buck brackets 162 (at least one) is anticipated, depending upon the size of the opening and strength required.

In FIG. 11, one section 160 of the fifth buck system is shown with buck brackets 162, ready to be connected to an adjacent section 160 of the fifth buck system. The section 160 of buck system is shown placed over the two sides 4/5 of the ICF. Note, it is fully anticipated to include the soft material barrier 8 (as shown in FIGS. 1A, 1B, 2A, 3A, 4A, and 4B) in any of the described buck systems, including those shown in FIGS. 9 through 11. When included, the soft material barrier 8 (e.g. Styrofoam or other soft material) improves insulation and provides a barrier to the concrete that, after the concrete sets, improves the ability to screw or nail into the surface 178 of the buck sections 160.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A buck system for forming and framing an opening in a poured concrete foundation, the foundation poured between two insulated concrete foundation walls, the buck system comprising:
a plurality of buck sections of lengths that match the desired dimension of the opening, each of the plurality of buck sections affixed to an adjacent buck section of the plurality of buck sections by brackets forming a closed geometric shape, each of the buck sections having a first side section, a second side section and a center section, the first side section affixed to a first top surface of the center section and the second side section affixed to a second, distal top surface of the center section; the first side section having an first side section outer wall, forming a first channel between the inner surface of the first side section outer wall and a first side of the center section; the second side section having a second side section outer wall, forming a second channel between the inner surface of the second side section outer wall and a second side of the center section; the first channel snuggly accepts an edge of a first insulated concrete foundation wall of the two insulated concrete foundation walls and the second channel snuggly accepts an edge of a second insulated concrete foundation wall of the two insulated concrete foundation walls.

2. The buck system of claim 1, wherein the first side section further comprises a first side section inner wall, forming the first channel between the inner surface of the first side section outer wall and first side section inner wall; the second side section further comprises a second side section inner wall, forming the second channel between the inner surface of the second side section outer wall and the second side section inner wall.

3. The buck system of claim 1, wherein the center section is an industry standard C-stud.

4. The buck system of claim 1, further comprising an insulative material disposed within the center section.

5. The buck system of claim 1, wherein the first side section affixed to the first top surface of the center section with screws, and the second side section affixed to the second top surface of the center section with screws.

6. The buck system of claim 1, wherein each of the first side section outer wall and the second side section outer wall includes inwardly facing barbs.

7. The buck system of claim 2, wherein each of the first side section inner wall and the second side section inner wall includes inwardly facing barbs.

8. A method of making a framed opening in a poured concrete foundation, the foundation poured between two insulated concrete foundation walls, the method comprising:
providing a plurality of the buck sections of claim 1 of lengths that match the desired dimension of the opening, the width of the center sections being approximately the distance between inside surfaces of the two insulated concrete foundation walls;
affixing each of the plurality of buck sections to an adjacent buck section of the plurality of buck sections forming a closed geometric shape;
positioning edges of a first insulated concrete foundation wall of the insulated concrete foundation walls into the first channel;
positioning edges of a second insulated concrete foundation wall of the insulated concrete foundation walls into the second channel; and
pouring concrete between the first insulated concrete wall and the second insulated concrete wall.

9. The method of claim 8, further comprising the step of inserting the insulative material within the center section before the step of pouring.

10. The method of claim 9, wherein the step of affixing includes affixing a first side of an angle bracket to an edge of the each of the plurality of buck sections and affixing a second side of the angle bracket to an adjoining edge of the adjacent buck section of the plurality of buck sections.

11. The method of claim 9, wherein the step of affixing includes screwing a first side of an angle bracket to an edge of the each of the plurality of buck sections and screwing a second side of the angle bracket to an adjoining edge of the adjacent buck section of the plurality of buck sections.

12. The method of claim 9, wherein the step of affixing includes affixing a first side of a buck bracket to an edge of the each of the plurality of buck sections and affixing a second side of the buck bracket to an adjoining edge of the adjacent buck section of the plurality of buck sections.

13. The method of claim 9, wherein the step of affixing includes screwing a first side of a buck bracket to an edge of the each of the plurality of buck sections and screwing a second side of the buck bracket to an adjoining edge of the adjacent buck section of the plurality of buck sections.

14. A buck system for forming and framing an opening in a poured concrete foundation, the foundation poured between two insulated concrete foundation walls, the buck system comprising:
a plurality of buck sections lengths that match the desired dimension of the opening, each of the plurality of buck sections affixed to an adjacent buck section of the plurality of buck sections forming a closed geometric shape, each of the buck sections having a center section made from a C-stud, each buck section having a first side section affixed to a first side of the center section, and a second side section affixed to an opposing side of the center section; the first side section having a first side section outer wall, forming a first channel between the inner surface of the first side section outer wall and a first side of the center section; the second side section having a second side section outer wall, forming a second channel between the inner surface of the second side section outer wall and a second side of the center section; the first channel snuggly accepts an edge of a first insulated concrete foundation wall of the two insulated concrete foundation walls and the second channel snuggly accepts an edge of a second insulated concrete foundation wall of the two insulated concrete foundation walls.

15. The buck system of claim 14, wherein the first side section further comprises a first side section inner wall, forming the first channel between the inner surface of the first side section outer wall and first side section inner wall; the second side section further comprises a second side section inner wall, forming the second channel between the inner surface of the second side section outer wall and the second side section inner wall.

16. The buck system of claim 14, further comprising an insulative material disposed within the center section.

17. The buck system of claim 14, wherein the first side section is affixed to the first side of the center section with screws, and the second side section is affixed to the second opposing side of the center section with screws.

18. The buck system of claim 14, wherein each of the first side section outer wall and the second side section outer wall includes inwardly facing barbs.

19. The buck system of claim 15, wherein each of the first side section inner wall and the second side section inner wall includes inwardly facing barbs.
